(19) United States
(12) Patent Application Publication
(10) Pub. No.: US 2012/0277117 A1
(43) Pub. Date: Nov. 1, 2012

(54) HYDROPONIC APPARATUS AND METHODS OF USE

(76) Inventors: Adel Zayed, Durham, NC (US); Michael L. Jones, Raleigh, NC (US); Chris Tierney, Apex, NC (US); Matthew Miller, Raleigh, NC (US)

(21) Appl. No.: 13/203,516

(22) PCT Filed: Feb. 26, 2010
(86) PCT No.: PCT/US2010/025568

§ 371 Date: Jan. 25, 2012

Related U.S. Application Data
(60) Provisional application No. 61/156,283, filed on Feb. 27, 2009.

(51) Int. Cl. C40B 60/12; C40B 30/06

(52) U.S. Cl. 506/10; 506/39

(57) ABSTRACT

Hydroponic apparatus and methods for the high-throughput screening plants are disclosed. In one aspect, a method for the high-throughput screening of plants is disclosed. The method comprises germinating a plurality of plants in a hydroponic apparatus; selecting one or more plants having substantially uniform qualities from the plurality of germinated plants to form a population of plants; growing the population of selected plants in a controlled environment; and screening one or more plants in the population at least once during a growing period to determine the presence or absence of one or more predetermined characteristics

### CROSS REFERENCE TO RELATED APPLICATIONS

This application claims priority (as a U.S. National Phase Application filed under 35 U.S.C. §371) to International Patent Application No. PCT/US2010/025568 (filed Feb. 26, 2010), which in turn claims priority to U.S. Provisional Application Ser. No. 61/156,283 (filed Feb. 27, 2009). The entire text of each of these priority patent applications contents is incorporated by reference into this patent.

### FIELD OF THE INVENTION

The present invention relates to the use of hydroponics in the growth and analysis of plants.

### BACKGROUND OF THE INVENTION

Unlike soil, hydroponics provide complete and precise nutritional and water control, eliminate the need for precise watering schedules, ability to manipulate nutrient levels “on the fly” (depletion and recovery), ability to characterize root growth and morphology, provide clean root and shoot tissues for chemical, metabolic and molecular analysis, and is fully compatible with root and shoot imaging and image analysis techniques. Plants grown hydroponically can be grown in humid air, in an inert substance with water around it, or in water infused with air.

Hydroponics methods have several advantages over traditional soil gardening. The growth rate on a hydroponic plant can be up to 50 percent faster than a soil plant, grown under the same conditions. Hydroponically-grown plants can also provide greater yield. The extra oxygen in the hydroponic growing mediums helps to stimulate root growth. Plants with ample oxygen in the root system also absorb nutrients faster. The nutrients in a hydroponic system are mixed with the water and sent directly to the root system; thus, the plant does not have to search in the soil for the nutrients that it requires. Those nutrients are being delivered to the plant several times per day. The hydroponic plant requires very little energy to find and break down food. The plant then uses this saved energy to grow faster and to produce more fruit. Hydroponic plants also have fewer problems with pest infestations, fungi, and disease. Hydroponic gardening also offers several benefits to our environment as it uses considerably less water than soil gardening, because of the constant reuse of the nutrient solutions.

For the development of agronomically important traits, hydroponics offers a means for in-depth lead follow-up, closer monitoring and adjustment of nutrition, temperature and lighting than that of soil-based greenhouse or field conditions, allows ease of mechanism of action studies, uptake studies, characterization of root growth and morphology, complete and precise nutritional control, ability to manipulate nutrient levels “on the fly” (depletion/recovery), eliminates the need for precise watering schedules, is compatible with root and shoot imaging and image analysis, and provides clean root and shoot tissues for chemical and metabolic analyses.

### SUMMARY OF THE INVENTION

Briefly, therefore, the present invention is directed to processes for the enzymatic production of phosphinothricin from nitrile-containing substrates or precursors.

In one aspect, a system for high-throughput screening of plants is described. The system comprises a hydroponics subsystem and an imaging subsystem. The hydroponics subsystem comprises at least one first tray, a second tray, and a reservoir in fluid communication with the second tray. The at least one first tray is further described as comprising a plurality of compartments, wherein each compartment is adapted to hold at least one seed. The second tray is further described as being adapted for holding the at least one first tray and for receiving a nutrient solution. The second tray has three side walls and a bottom with a plurality of effluent drains in the side walls. Each effluent drain is arranged at a different vertical position in the side wall from the other effluent drains; finally, the imaging subsystem is described as adapted to receive the first tray from said hydroponics subsystem for capturing images of plants.

In another aspect, a method for the screening plants for one or more predetermined characteristics is described. The method comprises germinating a plurality of plants in a hydroponic apparatus, selecting one or more plants having substantially uniform qualities from the plurality of germinated plants to form a population of plants, growing the population of selected plants in a controlled environment; and screening one or more plants in the population at least once during a growing period to determine the presence or absence of one or more predetermined characteristics.

Other objects and features will be in part apparent and in part pointed out hereinafter.

### BRIEF DESCRIPTION OF THE DRAWINGS

The drawings described herein are for illustration purposes only and are not intended to limit the scope of the present teachings in any way.

FIG. 1 is a schematic of a hydroponic system, in accordance with various embodiments of the present disclosure.

FIG. 2 is a sketch of the carrier showing the top view.

FIG. 3 is schematic for the carrier system for individual plant imaging in side view

FIG. 4 is a schematic for the carrier from top view

### DETAILED DESCRIPTION OF THE PREFERRED EMBODIMENTS

Described herein the present invention discloses and claims novel hydroponics apparatus and methods of utilizing such apparatus in the growth and analysis of plants.

Numerous greenhouse and growth chamber studies have been conducted to link selected physiological and phenotypic traits measured in young seedlings (e.g., chlorophyll content and fluorescence, biomass, height, growth rate) to yield measured in fully mature plants. The ultimate goal is to provide breeders with a quick selection tool to screen seedlings of various genotypes and transgenic lines for their yield potential, product quality, and/or tolerance to environmental stresses and therefore saving substantial amounts of effort, time and money. Most of these controlled environment experiments are carried out using soil-based systems which limit the ability to fully control nutrient and water input due to the inherent variability of the soil. In addition, in nutritional and osmotic studies it might be easy to increase the concentration of a specific nutrient or salt in soil but it is much more problematic and challenging to attempt to deplete a specific salt or salts without affecting other soil components. Furthermore, it is extremely cumbersome to collect root-specific data and the root system is therefore ignored in most of these studies. This is despite the fact that root morphology (e.g., root length and radius) and architecture (e.g., branching pattern) are the primary traits that influence plant resource (nutrients and water) acquisition.

Two common types of hydroponics apparatus feature nutrient circulation (or recirculation) systems that either maintain a thin film of nutrient solution on the root mass at all times (Nutrient Film Technique, or NFT), or expose the root mass to cycles of submersion and total draining (Drain/Flood, a.k.a. Ebb/Flow). Each allows root exposure to both nutrients and oxygen (either in the air or dissolved in the nutrient solution) in different temporal and spatial patterns. The improved hydroponics apparatus of the present invention enables optimal control of root exposure to nutrients and water.

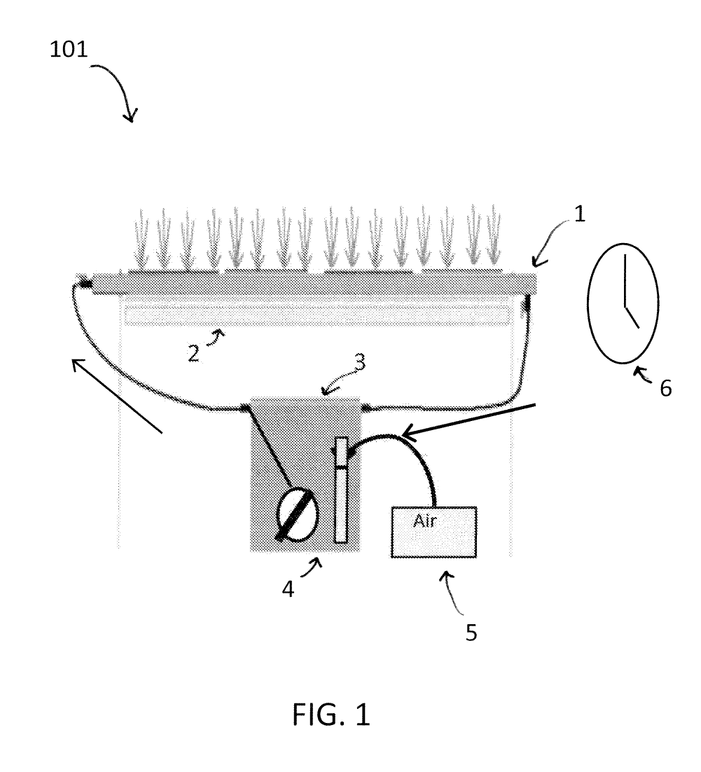

Referring now to FIG. 1, one aspect of the invention comprises a hydroponic apparatus 101 for the hydration and imbibitions of at least one plant seed. The apparatus 101 comprises including a at least one first tray 1 for holding a plurality of plant seed. The at least one first tray 1 is arranged above a second tray 2 that is adapted to receive a nutrient solution. The nutrient solution in second tray 2 is supplied from a reservoir 3 that is in fluid communication with second tray 2 via pumping means 4. The hydroponic apparatus 101 can further comprise an aeration device 5 for oxygenating the nutrient solution prior contacting plant tissue in second tray 2. A timing or control device 6 may be further added to the apparatus 101 for controlling the operation of the pump 4 at discrete time intervals.

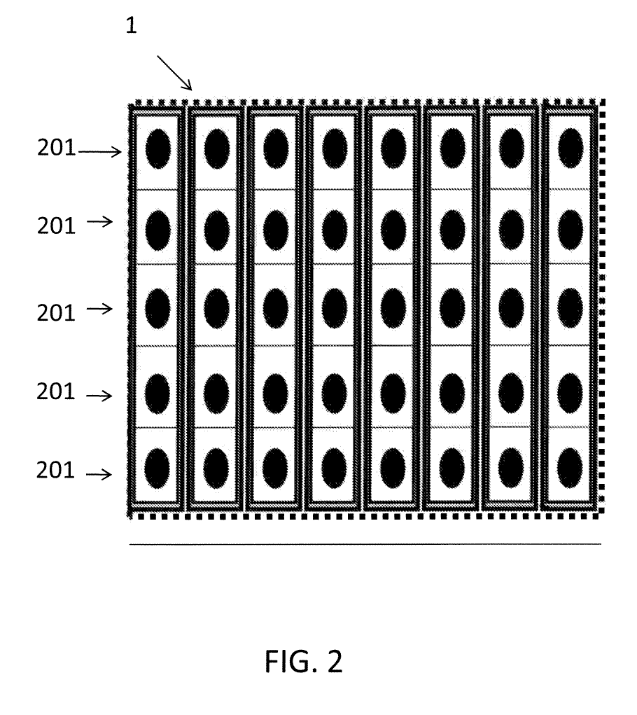

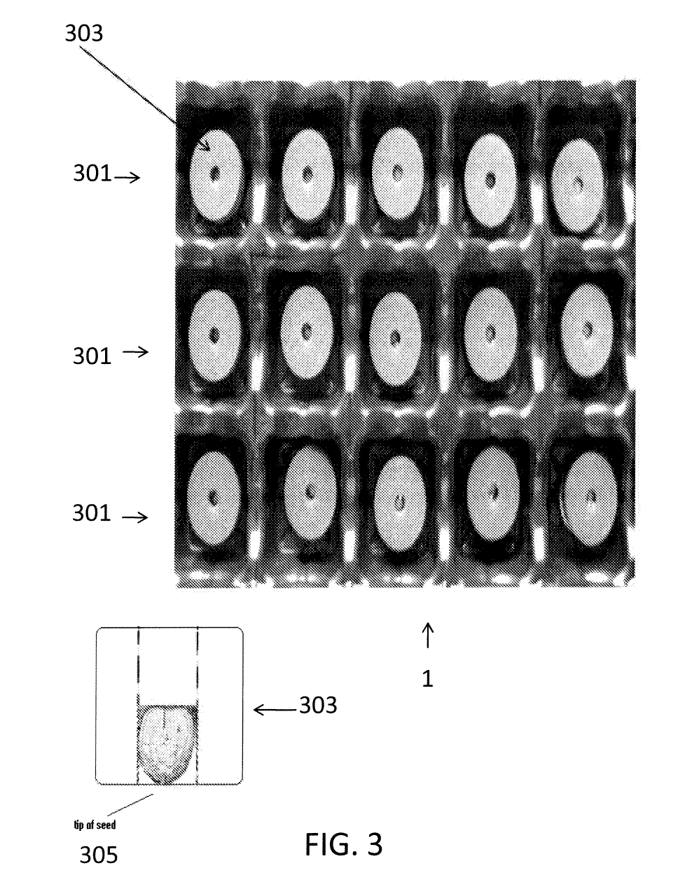

In at least one embodiment, the first tray 1 comprises a plurality of compartments, each of which. The first tray 1 may further be arranged so that multiple plants could be grown in the same tray at the same time. Examples of such arrangements is the inclusion of independent plant holders that are either joined together or are removable as shown in FIGS. 2 through 8. The invention further discloses a carrier system that comprises individual plant holders, that are used for the growth and subsequent imaging of the plants contained therein. By the term “independent plant holder” it is meant an apparatus for the containment of a single seed, or germinating seed, or plantlet, or plant, for its growth in a hydroponics system. By the term “carrier system”, it is meant a collection of such individual plant holders each of which are removable components that are also capable of being joined together. Plants that are arranged in a hydroponics apparatus in such a carrier system comprising individual plant holders may thus be screened in a high-throughput manner as each plant may be removed individually for analysis without subjecting the plant to root damage or other types of physical stress. Benefits of such an improved plant holder and carrier system apparatus include the ability to achieve single plant imaging, the system is interchangeable with aeroponic baskets, Caplug and Identiplug setups, it allows for easy movement between chamber and image station, and it is compatible with double containment needs.

An additional feature of the described hydroponics apparatus is the presence of a plurality of effluent drains that are used to control the depth of the influent nutrient solution. An example for such plurality of effluent drains is given in FIG. 9. The apparatus tray is connected to fluid conveyance devices (tubing, pipes, or the like) that drain the influent nutrient solution into either a waste receptacle or back into the nutrient fluid reservoir for recirculation. In one aspect of the invention, there is a plurality of effluent drains included in the lower tray, each connected to either a common fluid conveyance device or to individual fluid conveyance devices. In one aspect of the invention, at least two effluent drains are positioned at different vertical positions, to allow for differential fluid level maintenance. Stoppers may optionally be used to prevent the flow of liquid into one or more effluent drains. By “vertical position”, it is contemplated that this is defined by the vertical spacing of the effluent drains on one of the vertical sides of the tray. Alternatively, it is contemplated that “vertical position” is defined by different heights of effluent fluid conveyance devices connected to the bottom horizontal surface of the tray. Another alternative contemplation of the term “vertical position” is a different horizontal position of effluent fluid conveyance devices situated above the plane of the bottom of the apparatus and draining the fluid from above. It is the purpose of these multiple different fluid conveyance devices to automatically control the depth of the liquid to which the developing plant roots are exposed. In one aspect of the invention, three effluent drains are employed in such a manner as to provide liquid depth control for minimum root exposure, partial or total root exposure, and a third effluent drain to act as an “overflow” relief drain. In such an apparatus, the hydroponic growth conditions allow the developing plant root to be exposed to nutrients, water and air for an optimally determined time that would not be possible with any of the apparatus known in the art. The control of the air and nutrient solution may be manual or under the control of a timing device.

The hydroponics apparatus described herein may be situated in such a fashion such that one tray (comprising an individual plant, individual plant holder, or a plurality of individual plant holders) can be used as a single, standalone apparatus (a collection of standalone apparatus is demonstrated in FIG. 10). In a different embodiment, the apparatus may be arranged in a “multi-tray” setup, such that multiple trays are arranged together in a single plane, such as demonstrated in FIG. 11. In yet another embodiment, the apparatus may be arranged in a “multi-tier” setup, such that multiple trays are stacked in a vertical plane. In yet another embodiment, the apparatus is arranged in a “multi-tray/multi-tier” setup, such that multiple trays are arranged together in multiple planes and multiple horizontal arrangements, such as demonstrated in FIG. 12. Any of such systems may be functionally linked to a common nutrient reservoir, a common pump, a common effluent system, or any combination thereof. Any of such systems may alternatively employ individual reservoirs, pumps, and/or effluent systems.

Plants grown in the disclosed apparatus may be further used in a method of screening or selecting those plants for a particular phenotypic characteristic. Such characteristics may include the effects of exposure to abiotic or biotic stress. Abiotic stress may be defined as nonliving environmental factors. Some of these factors include but are not limited to: drought, extreme cold or heat, high winds. Biotic stress may be defined as living organisms which can harm plants. Examples include but are not limited to: viruses, fungi, and bacteria, and insects.

One improvement that this apparatus provides is the ability to utilize its trays in a high-throughput analysis process. FIG. 13 depicts the usage of the plant carrier system as part of the disclosed improved hydroponics apparatus in high-throughput image analysis.

The disclosed, described and claimed hydroponics apparatus of the present invention has been successfully used to germinate, grow and screen plants from corn, soybean, canola and Arabidopsis.

The following definitions can be used to understand the invention.

“Genotype” describes the genetic constitution of an individual plant; distinct genotypes can be defined by the specific allelic makeup of individual plants or by a transgene in a transgenic plant when compared to a matched nursery control plant.

As used herein “grow” and “grown” describe the cultivation of plants to a desired stage, for example to harvest or an earlier maturity state.

A dicot plant is a member of a group of flowering plants whose seed typically contains two embryonic leaves or cotyledons. A monocot plant is a member of a group of flowering plants having one embryonic leaf. Crop plants are plants that are commonly cultivated. The screening of crop plants is a useful application of the methods of this invention. Monocot crop plants include, but are not limited to, wheat, corn (maize), rice; and dicot crop plants include tomato, potato, soybean, cotton, canola, sunflower and alfalfa.

“Biotic stress” is a stress on a plant caused by any factor that is itself alive such as plant pests. Plant pests include, but are not limited to arthropod pests, nematode pests, and fungal or microbial pests. “Abiotic stress” is a stress on a plant caused by one or more non-living chemical and physical factors in the environment such as light, temperature, water, atmospheric gases, wind as well as soil, and physiographic factors. Abiotic stresses useful for applying to plants being screened for genotypes that provide enhanced traits include water deficit stress, nitrogen deficit stress, cold stress, heat stress, sunlight stress (e.g. from shade). As used herein the term “stress” means variation from optimal conditions to sub-optimal conditions of growth.

“Trait” refers to a plant phenotype and is generally observable from an interaction between the genotype of the plant and the environment. A trait can be observed by the naked eye or by any other means of evaluation known in the art, for example microscopy, biochemical analysis, imaging in the visible range, imaging in the hyperspectral range, etc. At least one “measurable characteristic” is used to quantitatively describe a specific trait. Such characteristics can be, but are not limited to plant height, plant width, image-derived plant biomass, image-derived plant growth rate, plant morphology, plant weight, total plant or plant part dry matter weight, plant color, chlorophyll content, anthocyanin content, water content, leaf number, leaf angle germination rate, yield, leaf extension rate, chlorophyll level, ear length, ear diameter, ear tip void percentage, kernels per ear, average mass per kernel, total each shell weight, boll count, seed cotton weight, fruit and seed size, harvest moisture, husk length, stand count at harvest time in a unit area or per plot, metabolite quality and quantity which include oil, protein, carbohydrate or any other plant metabolite, food or feed content and value, and the like.

The trait selected by the screening methods of the invention can be any quantitative or qualitative trait. In some embodiments the trait selected by screening is enhanced yield, enhanced resistance to an abiotic stress or enhanced yield by enhanced resistance to an abiotic stress. In other embodiments the trait selected by screening is resistance or tolerance to an herbicide. In other embodiments, the trait is an enhanced trait such as resistance to a biotic stress such as enhanced resistance to soybean cyst nematode or corn rootworm, or boll weevil, or a virus or fungus. In other embodiments the trait is an enhanced trait such as root lodging, stalk lodging, plant lodging, plant height, plant morphology, ear development, tassel development, plant weight, plant maturity, total plant or plant part dry matter, fruit and seed size, harvest moisture, husk length, stand count at harvest time in a unit area or per plot, metabolite quality or content which include oil, protein, carbohydrate or any other plant metabolite, food or feed content and value, physical appearance, male sterility, and the like. As those skilled in the art will readily recognize, the invention may be practiced using any combination of phenotypic traits that may be imparted by different genotypes or, more specifically imparted by one or more transcribable polynucleotides introduced into plants being screened in a field or method of this invention.

The transcribable polynucleotide molecule preferably encodes a polypeptide that is suitable for incorporation into the diet of a human or an animal. Specifically, such transcribable polynucleotide molecules comprise genes of agronomic interest. As used herein, the term “gene of agronomic interest” refers to a transcribable polynucleotide molecule that includes but is not limited to a gene that provides a desirable characteristic associated with plant morphology, physiology, growth and development, yield, nutritional enhancement, disease or pest resistance, or environmental or chemical tolerance. Suitable transcribable polynucleotide molecules include but are not limited to those encoding a yield protein, a stress resistance protein, a developmental control protein, a tissue differentiation protein, a meristem protein, an environmentally responsive protein, a senescence protein, a hormone responsive protein, an abscission protein, a source protein, a sink protein, a flower control protein, a seed protein, an herbicide resistance protein, a disease resistance protein, a fatty acid biosynthetic enzyme, a tocopherol biosynthetic enzyme, an amino acid biosynthetic enzyme, or an insecticidal protein.

The expression of a gene of agronomic interest is desirable in order to confer an agronomically important trait. A gene of agronomic interest that provides a beneficial agronomic trait to crop plants may be, for example, including, but not limited to genetic elements comprising herbicide resistance (U.S. Pat. Nos. 6,803,501; 6,448,476; 6,248,876; 6,225,114; 6,107,549; 5,866,775; 5,804,425; 5,633,435; 5,463,175), increased yield (U.S. Pat. USRE38,446; 6,716,474; 6,663,906; 6,476,295; 6,441,277; 6,423,828; 6,399,330; 6,372,211; 6,235,971; 6,222,098; 5,716,837), insect control (U.S. Pat. Nos. 6,809,078; 6,713,063; 6,686,452; 6,657,046; 6,645,497; 6,642,030; 6,639,054; 6,620,988; 6,593,293; 6,555,655; 6,538,109; 6,537,756; 6,521,442; 6,501,009; 6,468,523; 6,326,351; 6,313,378; 6,284,949; 6,281,016; 6,248,536; 6,242,241; 6,221,649; 6,177,615; 6,156,573; 6,153,814; 6,110,464; 6,093,695; 6,063,756; 6,063,597; 6,023,013; 5,959,091; 5,942,664; 5,942,658, 5,880,275; 5,763,245; 5,763,241), fungal disease resistance (U.S. Pat. Nos. 6,653,280; 6,573,361; 6,506,962; 6,316,407; 6,215,048; 5,516,671; 5,773,696; 6,121,436; 6,316,407; 6,506,962), virus resistance (U.S. Pat. Nos. 6,617,496; 6,608,241; 6,015,940; 6,013,864; 5,850,023; 5,304,730), nematode resistance (U.S. Pat. No. 6,228,992), bacterial disease resistance (U.S. Pat. No. 5,516,671), plant growth and development (U.S. Pat. Nos. 6,723,897; 6,518,488), starch production (U.S. Pat. Nos. 6,538,181; 6,538,179; 6,538,178; 5,750,876; 6,476,295), modified oils production (U.S. Pat. Nos. 6,444,876; 6,426,447; 6,380,462), high oil production (U.S. Pat. Nos. 6,495,739; 5,608,149; 6,483,008; 6,476,295), modified fatty acid content (U.S. Pat. Nos. 6,828,475; 6,822,141; 6,770,465; 6,706,950; 6,660,849; 6,596,538; 6,589,767; 6,537,750; 6,489,461; 6,459,018), high protein production (U.S. Pat. No. 6,380,466), fruit ripening (U.S. Pat. No. 5,512,466), enhanced animal and human nutrition (U.S. Pat. Nos. 6,723,837; 6,653,530; 6,5412,59; 5,985,605; 6,171,640), biopolymers (U.S. Pat. USRE37,543; 6,228,623; 5,958,745 and U.S. Patent Publication No. US20030028917), environmental stress resistance (U.S. Pat. No. 6,072,103), pharmaceutical peptides and secretable peptides (U.S. Pat. Nos. 6,812,379; 6,774,283; 6,140,075; 6,080,560), improved processing traits (U.S. Pat. No. 6,476,295), improved digestibility (U.S. Pat. No. 6,531,648) low raffinose (U.S. Pat. No. 6,166,292), industrial enzyme production (U.S. Pat. No. 5,543,576), improved flavor (U.S. Pat. No. 6,011,199), nitrogen fixation (U.S. Pat. No. 5,229,114), hybrid seed production (U.S. Pat. No. 5,689,041), fiber production (U.S. Pat. Nos. 6,576,818; 6,271,443; 5,981,834; 5,869,720) and biofuel production (U.S. Pat. No. 5,998,700). The genetic elements, methods, and transgenes described in the patents listed above are incorporated herein by reference.

Alternatively, a transcribable polynucleotide molecule can effect the above mentioned plant characteristic or phenotype by encoding a RNA molecule that causes the targeted inhibition of expression of an endogenous gene, for example via antisense, inhibitory RNA (RNAi), or cosuppression-mediated mechanisms. The RNA could also be a catalytic RNA molecule (i.e., a ribozyme) engineered to cleave a desired endogenous mRNA product. Thus, any transcribable polynucleotide molecule that encodes a transcribed RNA molecule that affects a phenotype or morphology change of interest may be useful for the practice of the present invention.

The methods of this invention are practiced on a plant population that is exposed to a “controlled environment”. A controlled environment facilitates the screening of a population of plants in a set or subset of plants with an enhanced desired trait. For example, drought tolerant plants within a population are identified by exposing the plant population to drought; herbicide tolerant plants within a population are identified by exposing the plant population to a specific herbicide; insect tolerant plants within a population are identified by exposing the plant population to a specific insect; nitrogen deficit tolerant plants within a population are identified by exposing the plant population to a nitrogen deficit; and plants with enhanced yield within a population are identified by measuring plant height at various time points, determining chlorophyll fluorescence, differential light reflectrometry (Normalized difference vegetative index, NDVI) or transmission spectrometry (SPAD) or harvesting from individual plants to determine yield, such as grain yield. In one embodiment, standard statistical analyses methods (which include experimental blocking and spatial autocorrelation and trend analysis) allow infinitely large experiments to be planted in the field. These experiments enable easy and rapid tests of tens of thousands of genetic variants simultaneously in a single array location.

A “transgenic plant” means a plant whose genome has been altered by the stable integration of recombinant DNA. A transgenic plant includes a plant regenerated from an originally-transformed plant cell and progeny transgenic plants from later generations or crosses of a transformed plant. The term “non transgenic plant” means a plant whose genome has not been altered by stable integration of recombinant DNA. Non transgenic plants include natural plants and plants varieties that are created without using recombinant DNA technology.

A “control plant” means a plant that does not comprise a genotype being screened for a trait, e.g. a plant that does not comprise the recombinant DNA or mutant DNA. Including a number of control plants in a field provides a baseline for screening. A suitable control plant can be a non-transgenic plant of the parental line used to generate a transgenic plant, i.e. devoid of recombinant DNA. A suitable control plant may in some cases be a progeny of a hemizygous transgenic plant line that does not comprise the recombinant DNA, known as a negative segregant.

A negative control plant is one that exhibits a deleterious phenotype when exposed to conditions in an assay for said measureable characteristics. A positive control plant is one that exhibits a beneficial phenotype when exposed to conditions in an assay for said measureable characteristics.

Process controls are a set of 2 or more lines that are included in every assay run to assess the stability of assay conditions and data collection process. A process control plant is a commercial line with abundant quantity that is specific to the assay and is sown on each sow date to monitor a reproducible stability response from sow date to sow date. In our case, we have selected a commercial line. We expect a reproducible response each time.

The term “transformation” refers to the introduction of nucleic acid into a recipient host. The term “host” refers to bacteria cells, fungi, animals and animal cells, plants and plant cells, or any plant parts or tissues including protoplasts, calli, roots, tubers, seeds, stems, leaves, seedlings, embryos, and pollen. As used herein, the term “transformed” refers to a cell, tissue, organ, or organism into which has been introduced a foreign polynucleotide molecule, such as a construct. The introduced polynucleotide molecule may be integrated into the genomic DNA of the recipient cell, tissue, organ, or organism such that the introduced polynucleotide molecule is inherited by subsequent progeny. A “transgenic” or “transformed” cell or organism also includes progeny of the cell or organism and progeny produced from a breeding program employing such a transgenic plant as a parent in a cross and exhibiting an altered phenotype resulting from the presence of a foreign polynucleotide molecule. The term “transgenic” refers to an animal, plant, or other organism containing one or more heterologous nucleic acid sequences.

There are many methods for introducing nucleic acids into plant cells. The method generally comprises the steps of selecting a suitable host cell, transforming the host cell with a recombinant vector, and obtaining the transformed host cell. Suitable methods include bacterial infection (e.g. Agrobacterium), binary bacterial artificial chromosome vectors, direct delivery of DNA (e.g. via PEG-mediated transformation, desiccation/inhibition-mediated DNA uptake, electroporation, agitation with silicon carbide fibers, and acceleration of DNA coated particles, etc. (reviewed in Potrykus, et al., Ann. Rev. Plant Physiol. Plant Mol. Biol., 42: 205, 1991).

Technology for introduction of DNA into cells is well known to those of skill in the art. Methods and materials for transforming plant cells by introducing a plant polynucleotide construct into a plant genome in the practice of this invention can include any of the well-known and demonstrated methods including:

(1) chemical methods (Graham and Van der Eb, Virology, 54(2): 536-539, 1973; Zatloukal, et al., Ann. N.Y. Acad. Sci., 660: 136-153, 1992);

(2) physical methods such as microinjection (Capecchi, Cell, 22(2): 479-488, 1980), electroporation (Wong and Neumann, Biochim. Biophys. Res. Commun., 107(2): 584-587, 1982; Fromm et al., Proc. Natl. Acad. Sci. USA, 82(17): 5824-5828, 1985; U.S. Pat. No. 5,384,253, herein incorporated by reference) particle acceleration (Johnston and Tang, Methods Cell Biol., 43(A): 353-365, 1994; Fynan et al., Proc. Natl. Acad. Sci. USA, 90(24): 11478-11482, 1993) and microprojectile bombardment (as illustrated in U.S. Pat. Nos. 5,015,580; U.S. Pat. No. 5,550,318; U.S. Pat. No. 5,538,880; U.S. Pat. No. 6,160,208; U.S. Pat. No. 6,399,861; and U.S. Pat. No. 6,403,865, all of which are herein incorporated by reference);

(3) viral vectors (Clapp, Clin. Perinatol., 20(1): 155-168, 1993; Lu, et al., J. Exp. Med., 178(6): 2089-2096, 1993; Eglitis and Anderson, Biotechniques, 6(7): 608-614, 1988);

(4) receptor-mediated mechanisms (Curiel et al., Hum. Gen. Ther., 3(2):147-154, 1992; Wagner, et al., Proc. Natl. Acad. Sci. USA, 89(13): 6099-6103, 1992), and

(5) bacterial mediated mechanisms such as Agrobacterium-mediated transformation (as illustrated in U.S. Pat. No. 5,824,877; U.S. Pat. No. 5,591,616; U.S. Pat. No. 5,981,840; and U.S. Pat. No. 6,384,301, all of which are herein incorporated by reference);

(6) Nucleic acids can be directly introduced into pollen by directly injecting a plant's reproductive organs (Zhou, et al., Methods in Enzymology, 101: 433, 1983; Hess, Intern Rev. Cytol., 107: 367, 1987; Luo, et al., Plant Mol. Biol. Reporter, 6: 165, 1988; Pena, et al., Nature, 325: 274, 1987).

(7) Protoplast transformation, as illustrated in U.S. Pat. No. 5,508,184 (herein incorporated by reference).

(8) The nucleic acids may also be injected into immature embryos (Neuhaus, et al., Theor. Appl. Genet., 75: 30, 1987).

Any of the above described methods may be utilized to transform a host cell with one or more gene regulatory elements of the present invention and one or more transcribable polynucleotide molecules. Host cells may be any cell or organism such as a plant cell, algae cell, algae, fungal cell, fungi, bacterial cell, or insect cell. Preferred hosts and transformants include cells from: plants, Aspergillus, yeasts, insects, bacteria and algae.

The prokaryotic transformed cell or organism is preferably a bacterial cell, even more preferably an Agrobacterium, Bacillus, Escherichia, Pseudomonas cell, and most preferably is an Escherichia coli cell. Alternatively, the transformed organism is preferably a yeast or fungal cell. The yeast cell is preferably a Saccharomyces cerevisiae, Schizosaccharomyces pombe, or Pichia pastoris. Methods to transform such cells or organisms are known in the art (EP 0238023; Yelton et al., Proc. Natl. Acad. Sci. (U.S.A.), 81:1470-1474 (1984); Malardier et al., Gene, 78:147-156 (1989); Becker and Guarente, In: Abelson and Simon (eds.), Guide to Yeast Genetics and Molecular Biology, Methods Enzymol., Vol. 194, pp. 182-187, Academic Press, Inc., New York; Ito et al., J. Bacteriology, 153:163 (1983); Hinnen et al., Proc. Natl. Acad. Sci. (U.S.A.), 75:1920 (1978); Bennett and LaSure (eds.), More Gene Manipulations in Fungi, Academic Press, CA (1991)). Methods to produce proteins of the present invention from such organisms are also known (Kudla et al., EMBO, 9:1355-1364 (1990); Jarai and Buxton, Current Genetics, 26:2238-2244 (1994); Verdier, Yeast, 6:271-297 (1990); MacKenzie et al., Journal of Gen. Microbiol., 139:2295-2307 (1993); Hartl et al., TIBS, 19:20-25 (1994); Bergeron et al., TIBS, 19:124-128 (1994); Demolder et al., J. Biotechnology, 32:179-189 (1994); Craig, Science, 260:1902-1903 (1993); Gething and Sambrook, Nature, 355:33-45 (1992); Puig and Gilbert, J. Biol. Chem., 269:7764-7771 (1994); Wang and Tsou, FASEB Journal, 7:1515-1517 (9193); Robinson et al., Bio/Technology, 1:381-384 (1994); Enderlin and Ogrydziak, Yeast, 10:67-79 (1994); Fuller et al., Proc. Natl. Acad. Sci. (U.S.A.), 86:1434-1438 (1989); Julius et al., Cell, 37:1075-1089 (1984); Julius et al., Cell, 32:839-852 (1983)).

Methods for transforming dicotyledons, primarily by use of Agrobacterium tumefaciens and obtaining transgenic plants have been published for cotton (U.S. Pat. No. 5,004,863; U.S. Pat. No. 5,159,135; U.S. Pat. No. 5,518,908, all of which are herein incorporated by reference); soybean (U.S. Pat. No. 5,569,834; U.S. Pat. No. 5,416,011, all of which are herein incorporated by reference; McCabe, et al., Biotechnolgy, 6: 923, 1988; Christou et al., Plant Physiol. 87:671-674 (1988)); Brassica (U.S. Pat. No. 5,463,174, herein incorporated by reference); peanut (Cheng et al., Plant Cell Rep. 15:653-657 (1996), McKently et al., Plant Cell Rep. 14:699-703 (1995)); papaya; and pea (Grant et al., Plant Cell Rep. 15:254-258 (1995)).

Transformation of monocotyledons using electroporation, particle bombardment and Agrobacterium have also been reported. Transformation and plant regeneration have been achieved in asparagus (Bytebier et al., Proc. Natl. Acad. Sci. (USA) 84:5354 (1987)); barley (Wan and Lemaux, Plant Physiol 104:37 (1994)); maize (Rhodes et al., Science 240:204 (1988); Gordon-Kamm et al., Plant Cell 2:603-618 (1990); Fromm et al., Bio/Technology 8:833 (1990); Koziel et al., Bio/Technology 11:194 (1993); Armstrong et al., Crop Science 35:550-557 (1995)); oat (Somers et al., Bio/Technology 10:1589 (1992)); orchard grass (Horn et al., Plant Cell Rep. 7:469 (1988)); corn (Toriyama et al., Theor Appl. Genet. 205:34 (1986); Part et al., Plant Mol. Biol. 32:1135-1148 (1996); Abedinia et al., Aust. J. Plant Physiol. 24:133-141 (1997); Zhang and Wu, Theor. Appl. Genet. 76:835 (1988); Zhang et al., Plant Cell Rep. 7:379 (1988); Battraw and Hall, Plant Sci. 86:191-202 (1992); Christou et al., Bio/Technology 9:957 (1991)); rye (De la Pena et al., Nature 325:274 (1987)); sugarcane (Bower and Birch, Plant J. 2:409 (1992)); tall fescue (Wang et al., Bio/Technology 10:691 (1992)) and wheat (Vasil et al., Bio/Technology 10:667 (1992); U.S. Pat. No. 5,631,152, herein incorporated by reference).

The regeneration, development, and cultivation of plants from transformed plant protoplast or explants is well taught in the art (Weissbach and Weissbach, Methods for Plant Molecular Biology, (Eds.), Academic Press, Inc., San Diego, Calif., 1988; Horsch et al., Science, 227: 1229-1231, 1985). In this method, transformants are generally cultured in the presence of a selective media which selects for the successfully transformed cells and induces the regeneration of plant shoots (Fraley et al., Proc. Natl. Acad. Sci. U.S.A., 80: 4803, 1983). These shoots are typically obtained within two to four months.

The shoots are then transferred to an appropriate root-inducing medium containing the selective agent and an antibiotic to prevent bacterial growth. Many of the shoots will develop roots. These are then transplanted to soil or other media to allow the continued development of roots. The method, as outlined, will generally vary depending on the particular plant strain employed.

The regenerated transgenic plants are self-pollinated to provide homozygous transgenic plants. Alternatively, pollen obtained from the regenerated transgenic plants may be crossed with non-transgenic plants, preferably inbred lines of agronomically important species. Conversely, pollen from non-transgenic plants may be used to pollinate the regenerated transgenic plants.

The transformed plants are analyzed for the presence of the genes of interest and the expression level and/or profile conferred by the regulatory elements of the present invention. Those of skill in the art are aware of the numerous methods available for the analysis of transformed plants. For example, methods for plant analysis include, but are not limited to Southern blots or northern blots, PCR-based approaches, biochemical analyses, phenotypic screening methods, field evaluations, and immunodiagnostic assays.

The seeds of the plants of this invention can be harvested from fertile transgenic plants and be used to grow progeny generations of transformed plants of this invention including hybrid plant lines comprising the construct of this invention and expressing a gene of agronomic interest. The present invention also provides for parts of the plants of the present invention. Plant parts, without limitation, include seed, endosperm, ovule and pollen. In a particularly preferred embodiment of the present invention, the plant part is a seed. The invention also includes and provides transformed plant cells which comprise a nucleic acid molecule of the present invention.

The transgenic plant may pass along the transformed nucleic acid sequence to its progeny. The transgenic plant is preferably homozygous for the transformed nucleic acid sequence and transmits that sequence to all of its offspring upon as a result of sexual reproduction. Progeny may be grown from seeds produced by the transgenic plant. These additional plants may then be self-pollinated to generate a true breeding line of plants. The progeny from these plants are evaluated, among other things, for gene expression. The gene expression may be detected by several common methods such as western blotting, northern blotting, immunoprecipitation, and ELISA.

Two effective methods for such transformation are Agrobacterium-mediated transformation and microprojectile bombardment. Microprojectile bombardment methods are illustrated in U.S. Pat. Nos. 5,015,580 (soybean); 5,550,318 (corn); 5,538,880 (corn); 5,914,451 (soybean); 6,160,208 (corn); 6,399,861 (corn); 6,153,812 (wheat) and 6,365,807 (rice) and Agrobacterium-mediated transformation is described in U.S. Pat. Nos. 5,159,135 (cotton); 5,824,877 (soybean); 5,463,174 (canola); 5,591,616 (corn); 6,384,301 (soybean), 7,026,528 (wheat) and 6,329,571 (rice), all of which are incorporated herein by reference. Transformation of plant material is practiced in tissue culture on a nutrient media, i.e. a mixture of nutrients that will allow cells to grow in vitro. Recipient cell targets include, but are not limited to, meristem cells, hypocotyls, calli, immature embryos and gametic cells such as microspores, pollen, sperm and egg cells. Callus may be initiated from tissue sources including, but not limited to, immature embryos, hypocotyls, seedling apical meristems, microspores and the like. Cells compriseing a transgenic nucleus are grown into transgenic plants.

In addition to direct transformation of a plant material with a recombinant DNA, a transgenic plant cell nucleus can be prepared by crossing a first plant having cells with a transgenic nucleus comprising recombinant DNA with a second plant lacking the transgenic nucleus. For example, recombinant DNA can be introduced into a nucleus from a first plant line that is amenable to transformation to transgenic nucleus in cells that are grown into a transgenic plant which can be crossed with a second plant line to introgress the recombinant DNA into the second plant line. A transgenic plant with recombinant DNA providing an enhanced trait, e.g. enhanced yield, can be crossed with transgenic plant line having other recombinant DNA that confers another trait, for example herbicide resistance or pest resistance, to produce progeny plants having recombinant DNA that confers both traits. Typically in such breeding for combining traits the transgenic plant donating the additional trait can be a male line and the transgenic plant carrying the base traits can be a female line. The progeny of this cross will segregate such that some of the plants will carry the DNA for both parental traits and some will carry DNA for one parental trait; such plants can be identified by markers associated with parental recombinant DNA, e.g. marker identification by analysis for recombinant DNA or, in the case where a selectable marker is linked to the recombinant, by application of the selecting agent such as a herbicide for use with a herbicide tolerance marker, or by selection for the enhanced trait. Progeny plants carrying DNA for both parental traits can be crossed back into the female parent line multiple times, for example usually 6 to 8 generations, to produce a progeny plant with substantially the same genotype as one original transgenic parental line but for the recombinant DNA of the other transgenic parental line.

Often effects of the environment can mask a trait imparted by a genotype, so the phenotype provides an imperfect measure of a plant's biological or genetic potential. Because of this, the methods of this invention are practiced on a plant population that is exposed to a “controlled environment”. A controlled environment should facilitate the screening of a population of plants in a set or subset of plants with an enhanced desired trait. For example, drought tolerant plants within a population can be identified by exposing the plant population to drought; herbicide tolerant plants within a population can be identified by exposing the plant population to a specific herbicide; insect tolerant plants within a population can be identified by exposing the plant population to a specific insect; nitrogen deficit tolerant plants within a population can be identified by exposing the plant population to a nitrogen deficit; and plants with enhanced yield within a population can be identified by measuring plant height at various time points, determining chlorophyll fluorescence, differential light reflectrometry (Normalized difference vegetative index, NDVI) or transmission spectrometry (SPAD) or harvesting from individual plants to determine yield, such as grain yield. In a useful embodiment, standard statistical analyses methods (which include experimental blocking and spatial autocorrelation and trend analysis) allow infinitely large experiments to be planted. These experiments could easily and rapidly test tens of thousands of genetic variants simultaneously.

As used herein “screening” is a process of identifying and using plants having desired traits from populations of plants that are grown in controlled environment of this invention and evaluated for a trait at one or more times during a growing period, wherein “selecting” means choosing one plant, one trait, and/or one transgenic event in preference to another. In the practice of this invention plant lines with genetic variation which confers better performance are identified and advanced to further testing. Moreover, the invention also allows the identification of plant lines with genetic variation which confers deleterious impacts on plant performance; such plants can be removed from further study populations.

As various modifications could be made in the apparatus and methods herein described and illustrated without departing from the scope of the invention, it is intended that all matter contained in the foregoing description or shown in the accompanying drawings shall be interpreted as illustrative rather than limiting. Having illustrated and described the principles of the present invention, it should be apparent to persons skilled in the art that the invention can be modified in arrangement and detail without departing from such principles. All such modifications in arrangement and detail are considered to fall within the spirit and scope of the appended claims. Thus, the breadth and scope of the present invention should not be limited by any of the above-described exemplary embodiments, but should be defined in accordance with the following claims appended hereto and their equivalents. Each cited publication is herein incorporated by reference in its entirety.

### EXAMPLES

The following non-limiting examples are provided to further illustrate the present invention.

### Example 1

This example describes the use of the hydroponics systems of the invention for the germination of corn plants.

Imbibition of corn seeds is performed in open cell polypropylene foam plugs (L800C from Jaece Industries. The foam is dyed a charcoal color which prevents light penetrance into the root containment area of the hydroponic system. The standard L800C product is customized to a size of 1.375″ diameter with a length of 0.875″. To facilitate sowing, a 7 mm hole is cored through the center to create a doughnut style configuration.

For the imbition of corn seeds customized Identi-plugs® are used to supply water and to support the plant during the early growth phase. Each identiplug can hold about 16 mm of water. The identiplug is saturated by squeezing the air out of the foam and then allowing the foam to expand under water. After saturating the identiplug with water, the seed is sown in the bottom of the identiplug with the seed tip facing down. The identiplug contains an appropriate mixture of water and air to facilitate hydration and imbibition of the seed. After sowing the seeds are incubated in the dark for 48 hours.

The seed will absorb moisture from the identiplug and the radicle emergence will begin between 24 and 36 hours after sowing. During this period of seed hydration and imbibition, it is critical that the identiplug is not allowed to sit in a pool of water or otherwise be in direct contact with water. The identiplug contains a perfect amount of moisture to facilitate germination and additional water will prevent germination.

As the radicle emerges from the seed and elongates, a path is be cleared for the root to grow without encountering any impervious surfaces. For this purpose 0.75″ holes were drilled in the bottom of each cell in a 32 pot flat. The identiplugs were placed in the cells above the holes, the flats were suspended in propagation domes above a shallow pool of water and the roots grew through the holes into the water.

After sowing the seed in the hydrated identiplug, the identiplug is placed in a HDPE apparatus, henceforth referred to as “germination raft”, which suspends the identiplug 0.375″ above a re-circulating nutrient solution.

The germination raft is designed to keep the identiplug out of the nutrient solution, to allow hydration and imbibition by uptake of water from the identiplug and to allow the identiplug to drain by gravity and dry by evaporation. The germination raft is also designed to standardize the distance between the seed and liquid level, to allow the nutrient solution to re-circulate below the germination raft, and to increase planting density.

The planting density was 42 plants per square foot, and the germination rate was about 95%.

### Example 2

### Soybean Germination

For the hydroponic germination and growth of soybeans the following materials were used: 6 mm Isolite (Sundine Enterprises, Inc), Aeroponic Baskets—Item #G5 (Teku), Caplugs (Part # CEC26 from Caplug), wire basket for rinsing Isolite, germination lids for MetroSystems, Metro Rack Hydroponic System, PVC spacers, humidity domes, Nutrient Media, 5 hole lids with 1.875″ hole

The Isolite is washed under frequent stirring in tap water until the effluent is clear. The appropriate number of aeroponic baskets are filled with Isolite to a depth of about 1″. A small dimple is created in the center of each Isolite filed basket for the seed to rest in.

The seed is placed on top of the Isolite, one seed per basket. The seed is covered with enough Isolite to hide seed (about ¼″-½″). To ensure a proper fit of the lid on the basket it is important that the Isolite does not come above the basket top. A Caplug with hole is used as the basket lid. The baskets are transferred to germination lids leveled with PVC spacers. A clear humidity dome is placed over each germination lid.

The germination Conditions were the following: the shelf height was 21 inches and temperatures were 25 C during days and 22 C during nights with a humidity of 70%. The photoperiod was 16 hours. Light Banks were used with (15 bulbs at about 350-400 uE at 21″ below shelf. The ebb-flow system was operated with a 30/30 on/off cycle. Nutrient height in tray was adjusted to cover bottom square of basket until germination. The nutrient solution was 0.5× Coopers for germination.

When 75% of seedlings have germinated, the humidity dome is removed. After 5 days seedling selection is performed based on the uniformity of growth. The selected baskets are transferred to lids with 1.875″ hole and placed on the MetroSystem. The system holds 8 lids.

The post-Germination Conditions were as follows: Shelf Height was 21 inches, Temperatures were set to 25 C during days and 22 C during nights with a humidity of 70% and a photoperiod of 16 hours. The light banks were 15 bulbs with about 350-400 uE at 21″ below shelf. The ebb-flow system was set to 15/45 on/off cycle and the nutrient height in the tray was adjusted to just below the bottom of the basket. The nutrient solution was 1× Coopers.

### Example 3

This example illustrates the use of the described hydroponic system for screening of transgenic soybean plants in low nitrogen and salinity stress assays. Soy seedlings were germinated in the NFT/ebb-flow hydroponics system using 0.5× Cooper's solution buffered with MES and allowed to grow for 7 days. After 7 days of growth, a uniform population of healthy plants for each event is selected and the solution is changed to low nitrogen conditions of 0.7 or 1.0 mM. The solution is replenished after 4 and 8 days from the change to low nitrogen. Eight days after nitrogen stress introduction, an image is taken for shoot biomass determination. Ten days after nitrogen stress introduction an image is taken for shoot biomass determination. The roots are cut, dried and weighed. Plants are grown under a 12 hour photoperiod with 26.5° C. days and 23° C. nights at an RH of 70% and 500-550 μE of white fluorescent light. Imaged analysis was used to predict shoot dry (pSDW) and fresh weights (pSFW). Root dry weights (RDW) were collected manually. Soybean Salinity Stress Assay—HydroponicsSoy seedlings were germinated in the NFT/Ebb-Flow hydroponics system using 0.5× Cooper's solution buffered with MES and allowed to grow for 5 days. After day 5 developmentally-matched healthy seedlings were transferred to buffered 1× Cooper's solution. Plants were rotated daily within the shelves. On day 7 the salt treatments began adding 33% of the salt each day for 3 days to obtain full concentration on last day, day 9. Solutions were fully changed to fresh batch of the appropriate concentration on day 12. Data was collected on day 18. The temperature was 26.5 C days, 23.0 C nights; humidity 70%, photoperiod 12 hour days and nights. Average light intensity was ˜480 uE, Imaged analysis was used to predict shoot dry (pSDW) and fresh weights (pSFW). Root dry weights (RDW) were collected manually.

What is claimed is:

1. A system for high-throughput screening of plants, the system comprising:
a. a hydroponics subsystem, the hydroponics subsystem comprising
at least one first tray comprising a plurality of compartments, each compartment adapted to hold at least one seed,
a second tray having three side walls and a bottom, the second tray being adapted for holding the at least one first tray and for receiving a nutrient solution, wherein said second tray further comprises a plurality of effluent drains in the side walls, each effluent drain being arranged at a different vertical position in said side wall from the other effluent drains,
a reservoir in fluid communication with said second tray, and
b. an oxygenation source; and an imaging subsystem, wherein the imaging subsystem is adapted to receive the first tray from said hydroponics subsystem.

2. The system of claim 1, wherein the second tray of the hydroponics subsystem comprises at least one effluent drain pipe attached to the bottom surface of said second tray.

3. The system of claim 2, wherein the second tray of the hydroponics subsystems comprises three or more effluent drains.

4. The system of claim 1, wherein the hydroponics subsystem further comprises a pump for delivering a nutrient solution from said reservoir to said second tray.

5. The system of claim 1, wherein said at least one first tray is suspended in nutrient solution in said second tray.

6. The system of claim 5, wherein said hydroponics subsystem comprises at least two first trays.

7. The system of claim 1, wherein the hydroponics susbsystem comprises a germination substrate disposed within each compartment in said at least one first tray.

8. The system of claim 7, wherein the germination substrate is selected from the group consisting of: clay, rock, sand, wool, pumice, plant fiber, wood, bark, perlite, gravel, polypropylene, polyurethane, polystyrene, foam plug, vermiculite, clay pellets, sawdust, coconut fiber, sphagnum peat moss, rice hulls, oasis cubes, rockwool, stonewool, and brick shards.

9. A high-throughput method of screening plants for one or more predetermined characteristics, the method comprising:
germinating a plurality of plants in a hydroponic apparatus;
selecting one or more plants having substantially uniform qualities from the plurality of germinated plants to form a population of plants;
growing the population of selected plants in a controlled environment; and
screening one or more plants in the population at least once during a growing period to determine the presence or absence of one or more predetermined characteristics.

10. The method of claim 9 wherein said plants are transgenic plants.

11. The method of claim 9 wherein said plants are crop plants.

12. The method of claim 9 applying a controlled environment to said apparatus wherein said environment is controlled for abiotic stress.

13. The method of claim 9 applying a controlled environment to said apparatus wherein said environment is controlled for biotic stress.

14. The method of claim 9 applying a controlled environment to said apparatus wherein said environment is controlled for a feature selected from the group consisting of water, essential plant nutrients, available light, substrate temperature, substrate aeration, substrate type, insects, and plant pathogens.

15. The method of claim 9, wherein said assessment is selected from the group consisting of:
visual examination, imaging, software analysis, chemical assay, biochemical assay, physical assay.

16. The method of claim 9, wherein said predetermined characteristic is selected from the group consisting of: root physiology, root morphology, nutrient uptake, metabolite profiling,

17. The method of claim 9 wherein said method further comprises a statistical methodology to compare said predetermined characteristics between two or more plants.

18. The method of claim 9, wherein the hydroponic apparatus comprises
at least one first tray comprising a plurality of compartments, each compartment adapted to hold at least one seed,
a second tray having three side walls and a bottom, the second tray being adapted for holding the at least one first tray and for receiving a nutrient solution, wherein said second tray further comprises a plurality of effluent drains in the side walls, each effluent drain being arranged at a different vertical position in said side wall from the other effluent drains, and
a reservoir in fluid communication with said second tray.
